(19) United States
(12) Patent Application Publication
(10) Pub. No.: US 2009/0284553 A1
(43) Pub. Date: Nov. 19, 2009

(54) METHOD OF DEFINING A GAME ZONE FOR A VIDEO GAME SYSTEM

(75) Inventor: Henri Seydoux, Paris (FR)

Correspondence Address: HAVERSTOCK & OWENS LLP, 162 N WOLFE ROAD, SUNNYVALE, CA, 94086, US

(73) Assignee: PARROT, PARIS (FR)

(21) Appl. No.: 12/446,606

(22) PCT Filed: Oct. 24, 2007
(86) PCT No.: PCT/FR2007/001748

§ 371 Date: May 19, 2009

(30) Foreign Application Priority Data
Nov. 9, 2006 (FR) 0609774

(51) Int. Cl. G09G 5/00; A63H 30/04; A63F 9/24; G06T 15/00; H04M 1/00; H04B 7/00

(52) U.S. Cl. 345/649; 446/456; 463/42; 345/660; 345/419; 455/556.1; 455/41.2

(57) ABSTRACT

The invention relates to a method of defining a game zone for a video game system. The system comprises a remotely-controlled vehicle (1) and an electronic entity (3) for remotely controlling the vehicle (1), the method comprising the following steps: acquiring the terrestrial position of the vehicle (1) via a position sensor (37) arranged on the vehicle (1); transmitting the terrestrial position of the vehicle (1) to the electronic entity (3); establishing a connection between the electronic entity (3) and a database (17) containing aerial images of the Earth; in the database (17), selecting an aerial image corresponding to the terrestrial position transmitted to the electronic entity (3); downloading the selected aerial image from the database (17) to the electronic entity (3); and incorporating the downloaded aerial image in a video game being executed on the electronic entity (3).

The invention relates to a method of defining a game zone for a video game system.

One such method is known in particular from document US 2004/0110565 A1. That document describes an individual watercraft having an incorporated game console. The driver of the watercraft has a head-up display on which virtual elements corresponding to the video game are displayed. The virtual elements blend into the driver's real view. The recreational watercraft also has a position sensor in the form of a global positioning system (GPS), the GPS being connected to the game console and enabling it to determine the current terrestrial position of the watercraft. According to that document, the position sensor incorporated in the watercraft enables a virtual game zone to be defined for a video game. To do this, the driver of the watercraft needs to take it to various real endpoints of the game zone. Once the watercraft has reached an endpoint of the game zone that is to be defined, the driver actuates the terrestrial position sensor so that it communicates the terrestrial position of the game zone endpoint to the game console. The driver of the watercraft thus passes via the various endpoints of the game zone, thereby enabling the terrestrial position of each endpoint to be acquired. With the various terrestrial positions being known, the game console is capable of generating a corresponding virtual game zone. That method of defining the game zone presents various drawbacks:

1) the player needs to travel with the watercraft in order to define the game zone, which can be tedious and take a long time, in particular if the game zone is of large extent;

2) that known solution consisting in traveling to the endpoints of the game zone is difficult to implement in game zones of complex shape, such as for example circuits with multiple curves for race games; and

3) the position sensor used, a GPS sensor, does not have sufficient resolution for certain games that are performed at a small scale.

Document US 2005/0186884 A1 describes a remotely-controlled toy vehicle having means for acquiring and transmitting the position of the vehicle, said position being considered relative to a frame of reference constituted by a game area. The position of the vehicle on the game area is acquired by sensors identifying the presence of the vehicle on the basis of its weight, or else by bar codes, magnets, or cables buried in the thickness of the game area, or indeed by a dead reckoning navigation system on board the vehicle, the position of the vehicle being evaluated by measuring its movement relative to a starting point on the game area.

However, insofar as the position of the vehicle is always identified relative to a specific relative frame of reference (the game area), the players can use the system only within the boundaries of the game area.

The object of the invention is to propose a method of defining a game zone for a video game system that overcomes the above-specified problems.

According to the invention, this object is achieved by a method of defining a game zone for a video game system, the system comprising a remotely-controlled vehicle and an electronic entity used for remotely controlling the vehicle, the method being characterized in that it comprises the following steps:
acquiring the terrestrial position of the vehicle via a position sensor arranged on the vehicle;
transmitting the terrestrial position of the vehicle to the electronic entity;
establishing a connection between the electronic entity and a database containing aerial images of the Earth;
in the database, selecting an aerial image corresponding to the terrestrial position transmitted to the electronic entity;
downloading the selected aerial image from the database to the electronic entity; and
incorporating the downloaded aerial image in a video game being executed on the electronic entity.

According to the invention, the game zone is constituted by a volume of greater or smaller size situated on the surface of the Earth. It may thus be constituted by a defined surface or territory, such as for example wasteland, certain parts of a courtyard in a building, a field, a garden, or a park, etc.

Compared with the technique of above-mentioned US 2005/0186884 A1, the invention makes it possible to use the system practically anywhere, because position is acquired in an absolute frame of reference (the Earth) without any need to have a complex and dedicated game area that is provided with numerous position sensors. In addition, acquiring an absolute terrestrial position (e.g. GPS coordinates), enables the invention to download an “aerial image” of the “terrestrial position” from a database, i.e. an image of the location on the Earth where the vehicle is to be found. With the system of US 2005/0186884 A1 that knows the position of the vehicle only relative to the game area, it is not possible to find in a database an appropriate aerial image that reproduces the real environment in which the vehicle exists.

The video game system may be any system that involves a graphics display of virtual elements on a screen. Under all circumstances, the system comprises a remotely-controlled vehicle and an electronic entity for remotely controlling the vehicle. The user of the video game system uses the electronic entity to drive the vehicle and simultaneously the video game is displayed on a screen of the electronic entity.

Preferably, the remotely-controlled vehicle is a toy capable of moving on the ground, in the air, and/or on water. By way of example, the remotely-controlled vehicle may correspond to a toy in the form of a race car, a helicopter, a tank, a boat, a motorcycle, etc. Thus, the remotely-controlled vehicle can be referred to as a “video toy”.

The electronic entity may be in the form of a portable game console or some other portable terminal, such as a personal digital assistant or a mobile telephone. If the electronic entity is a portable console, it may be constituted in particular by a portable Playstation (PSP) or a Nintendo DS (registered trademarks), or any other portable console presently on the market. The electronic entity must be capable of exchanging information with the vehicle in order to be able to control it remotely. Such an exchange of information may be performed via a wired connection between the vehicle and the electronic entity, however it is preferably performed by a wireless connection, preferably a radio connection, such as a connection using Bluetooth protocol (registered trademark of SIG Bluetooth), or WiFi protocol.

The first step of the method of the invention comprises acquiring the terrestrial position of the vehicle by means of a position sensor arranged on the vehicle. The terrestrial position of the vehicle corresponds to the location of the vehicle on the surface of the Earth. Preferably, this position is defined by angle measurements such as longitude and latitude.

The position sensor on board the vehicle is preferably a satellite positioning system module, in particular a GPS module. Nevertheless, it could also be a position sensor that does not depend on a satellite, for example a device implementing an inertial unit.

If it is a GPS sensor, then it communicates with a plurality of satellites in order to establish the terrestrial position of the vehicle.

In the method of the invention, the determined terrestrial position is transmitted to the electronic entity. This transmission may take place via any known transmission system, and preferably via a radio transmission system.

Once the electronic entity has received the terrestrial position of the vehicle, then, in accordance with the invention, it establishes a connection with a database containing aerial image of the Earth. Preferably, the database forms part of a computer network, in particular the Internet, and the connection between the electronic entity and the database takes place via a wireless local area network. Naturally, the connection between the electronic entity and the database may also be established by other means. In particular, it is possible for the electronic entity to be connected, e.g. via a cable, to a computer that has an Internet connection. Under such circumstances, the user may be connected to the database via the computer.

The terrestrial aerial images contained in the database may be satellite images, images taken from an aircraft such as an airplane or a helicopter, or any other surface images reproducing the characteristics of a portion of the surface of the Earth.

Once the connection between the electronic entity and the database has been established, then according to the invention an aerial image is selected from the database that corresponds to the terrestrial position of the vehicle as transmitted to the electronic entity. A search is thus made in the database for images giving an aerial view of the zone in which the remotely-controlled vehicle is to be found.

Once the aerial image corresponding to the terrestrial position of the vehicle has been found, this image is downloaded from the database to the electronic entity. If the electronic entity has a device giving it direct access to the database, e.g. a WiFi interface for access to the Internet, then the aerial photograph or image is transmitted directly from the database to the electronic entity. In contrast, if, as described above, downloading takes place via a computer, then the aerial image is initially transferred from the database to the computer, and subsequently from the computer to the electronic entity.

Finally, according to the invention, the downloaded aerial image that is now to be found in a memory of the electronic entity is incorporated in a video game that is being executed on the electronic entity.

By means of the method of the invention, it becomes possible to define a game zone for a video game system in a manner that is very convenient and easy. The user merely needs to place the remotely-controlled vehicle at the location where it is desired to play the video game. From there, the vehicle automatically acquires its terrestrial position, which it transits to the electronic entity, that in turn can automatically download a corresponding aerial image, assuming it has a device giving it direct access to the database. Thus, by the method of the invention for defining the game zone, the user is spared the tedious procedures of the kind needed in the above-described prior art. By virtue of the invention, the user can initialize the game in little time, moving little, and can quickly begin to do what the user really wants, i.e. play the game.

In a preferred application, the video game being executed on the electronic entity is a race game, the incorporation of the aerial image in the race game comprising positioning a virtual race circuit on the downloaded aerial image to enable a race game to be played that involves the remotely-controlled vehicle on the real terrain corresponding to the aerial image.

In this preferred embodiment, the user examines the downloaded aerial image as displayed on the screen of the electronic entity and compares it with the real environment in which the video toy or remotely-controlled vehicle is to be found. Preferably, the user may correct an error, if any, in the GPS measurement of the video toy by looking at the downloaded image displayed on the screen of the electronic entity, and then moving a graphics icon that is initially located at the position on the aerial image that corresponds to the geographical coordinates coming from the GPS measurement.

Preferably, the user can select a circuit from a set of circuits defined in a memory of the electronic entity. Thus, it is possible to place a geometrical shape that reproduces the shape of a race circuit on the aerial image. The virtual race circuit is not present on the real terrain where the remotely-controlled vehicle is located. In this way, it is possible to play a race game with a remotely-controlled vehicle without it being necessary to define a real race circuit on the real terrain. Thus, in this preferred application, a user is capable, a priori, of playing the race game anywhere since there is no need of a real race circuit to be installed on the game site.

Preferably, the positioning of the virtual circuit on the aerial image includes adapting the virtual circuit to the aerial image, in particular by shifting, rotation, pivoting, or scaling. In this way, the user can adjust the video game circuit on the aerial image.

The geometrical shape representing a modular circuit can thus be adapted to the real constraints present on the real terrain that has been selected to form the base of the game zone. For example, if the real terrain presents certain obstacles such as buildings, trees, trash cans, etc., it is now possible to deform the virtual circuit to accommodate the realities present on the game terrain.

It is also possible to envisage providing a function that enables a circuit to be drawn directly on the aerial image. Under such circumstances, either predefined elements such as turns, straight lines, and chicanes are used that can be subjected to scaling and pivoting so as to build up the circuit.

Otherwise, a circuit such as a ski competition slalom is drawn by defining points of passage that may be rings, tubes, bent tubes, and other three-dimensional geometrical shapes, in particular for flying vehicles such as, for example, quadricopters.

It is also possible to envisage that the incorporation of the aerial image in the video game comprises creating a five-face perspective image, the ground of the perspective image corresponding to the aerial image and the walls of the perspective image corresponding to images synthesized at infinity.

Creating such a perspective image with five faces is advantageously used in the video game to provide more effective and intuitive orientation for the player during the game, by making it possible to select views of the circuit in three dimensions, which views are encrusted in a three-dimensional aerial image.

There follows a description of implementations of methods of the invention, and of devices and systems representing ways in which the invention can be embodied, given with reference to the accompanying drawings in which the same numerical references are used from one figure to another to designate elements that are identical or functionally similar.

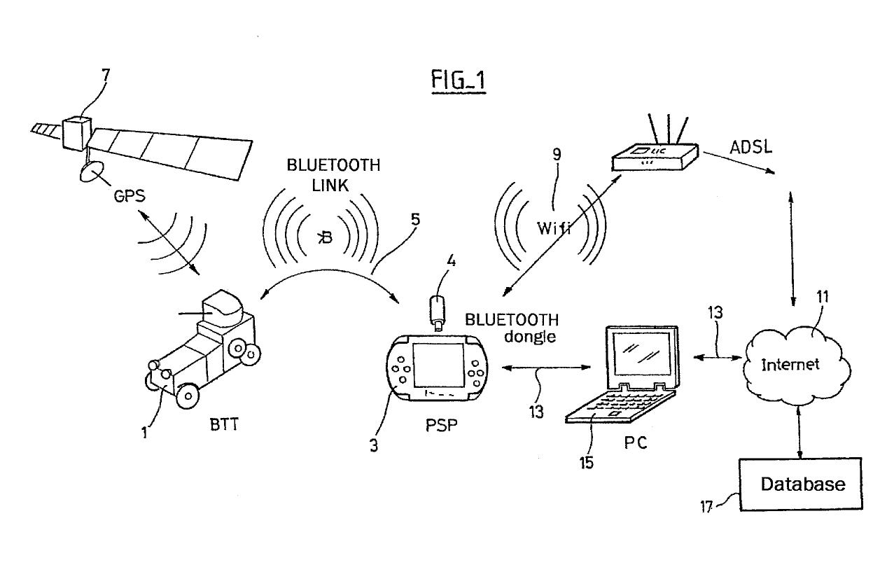

FIG. 1 is an overall view of the video game system of the invention;

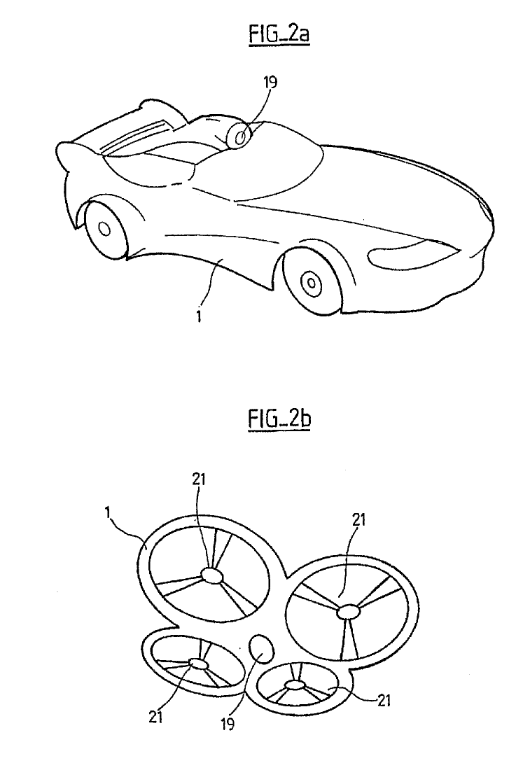

FIGS. 2a and 2b show two examples of remote-controlled vehicles of the invention;

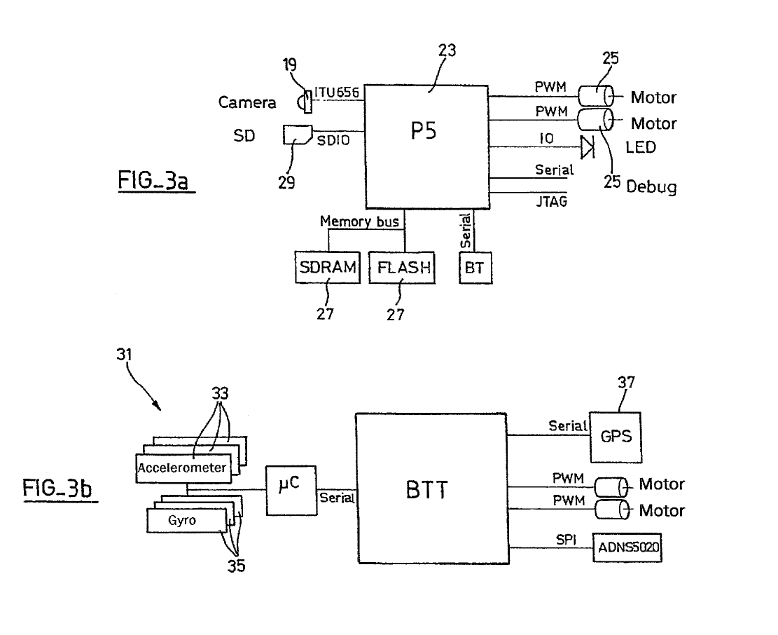

FIGS. 3a and 3b are block diagrams of the electronic elements of a remotely-controlled vehicle of the invention;

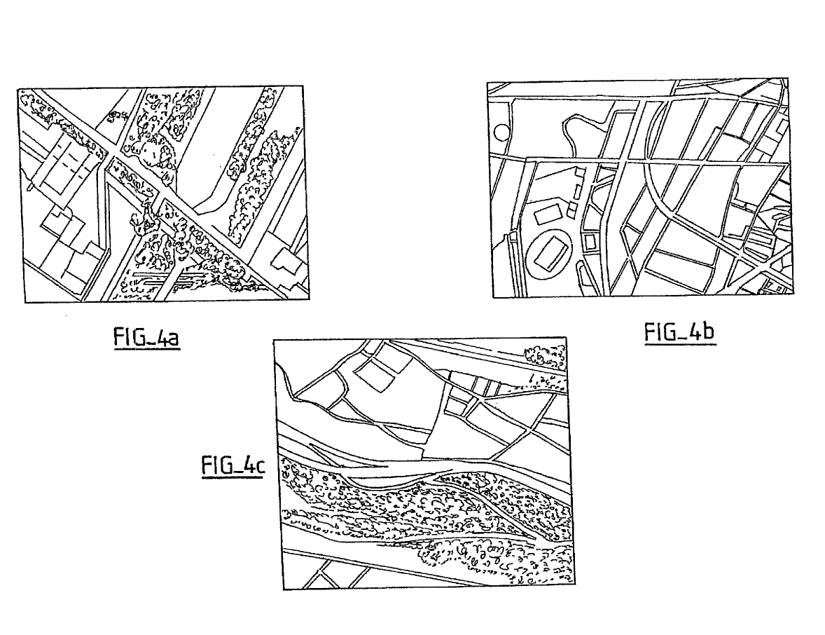

FIGS. 4a to 4c show various examples of aerial images in the video game system of the invention;

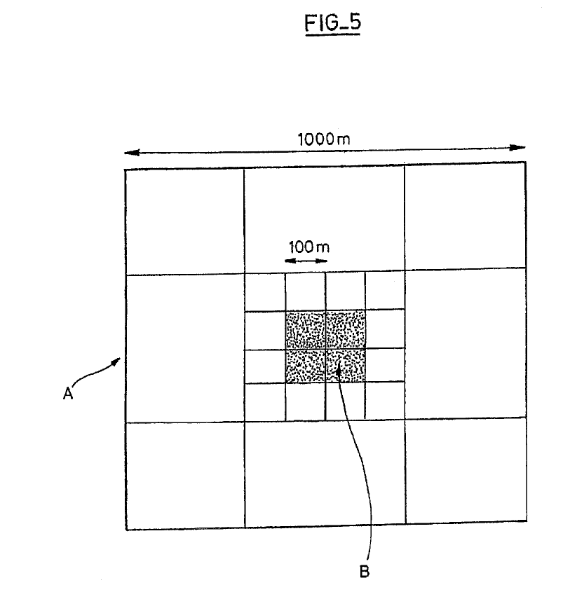

FIG. 5 shows a principle for defining game zones in the invention;

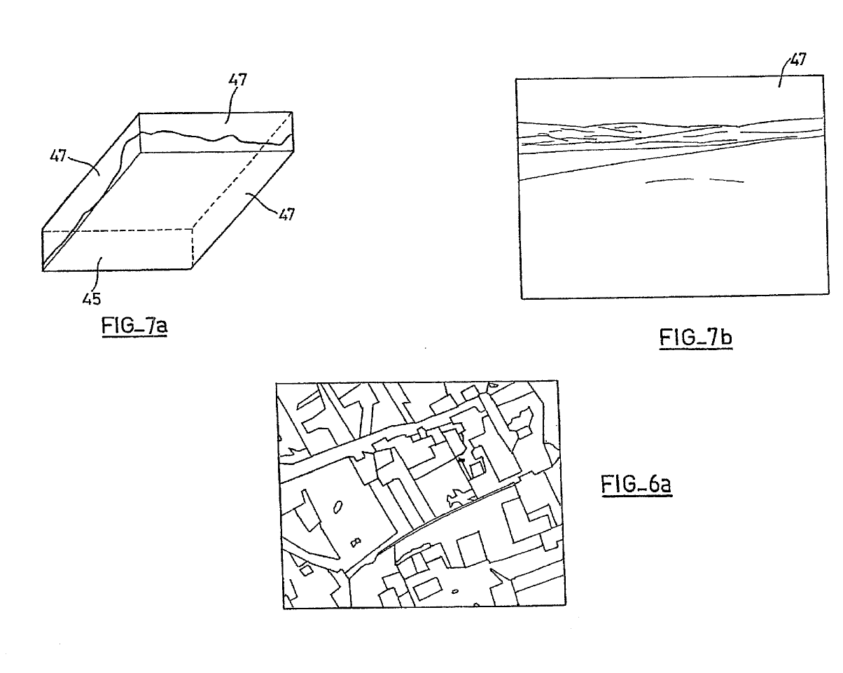

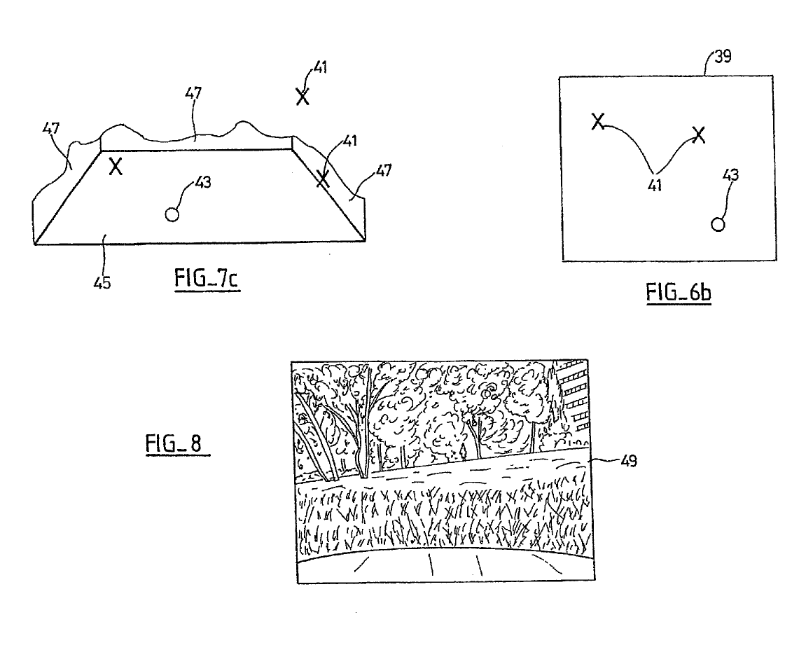

FIGS. 6a and 6b show the two-dimensional view of the invention;

FIGS. 7a to 7c show the perspective view of the invention;

FIG. 8 is an example of a view delivered by the video camera on board the remotely-controlled vehicle of the invention;

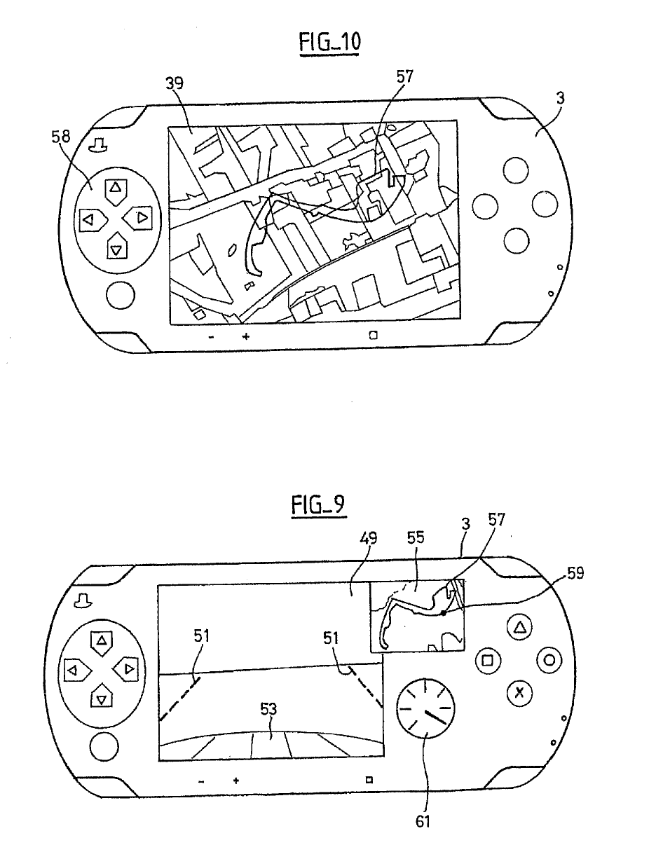

FIG. 9 shows an example of the display on the portable console of the invention;

FIG. 10 shows the virtual positioning of a race circuit on an aerial image of the invention;

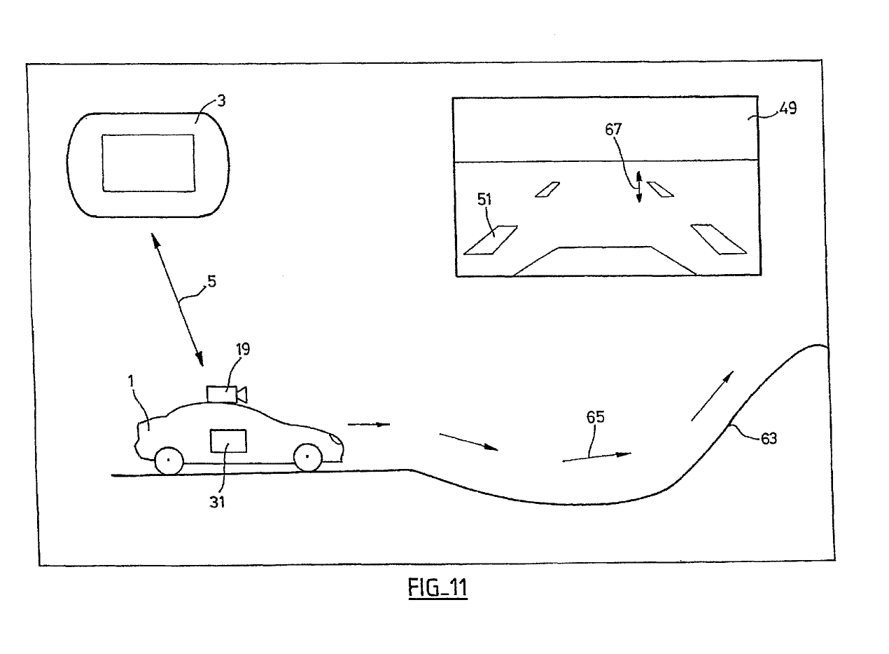

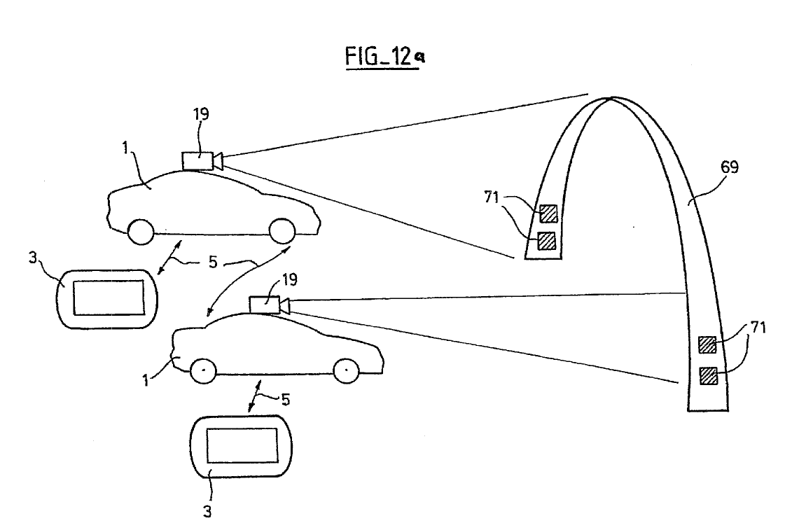

FIG. 11 shows the method of adjusting the display of the invention;

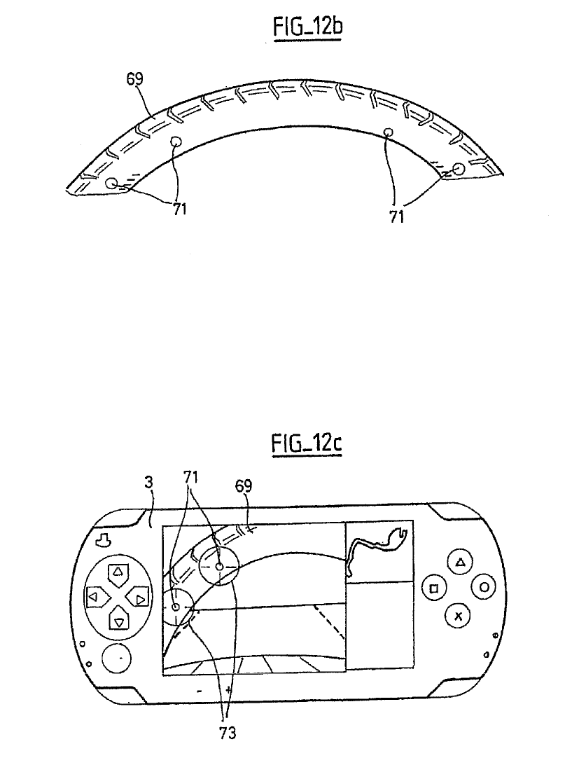

FIGS. 12a to 12c show a method of defining a common frame of reference of the invention; and

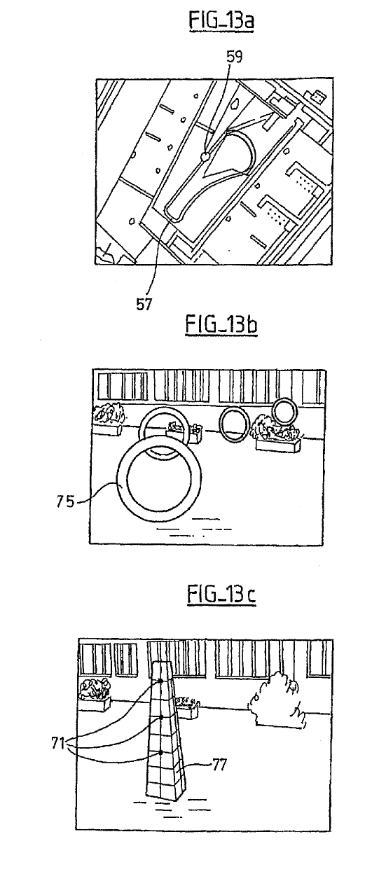

FIGS. 13a to 13c show an alternative version of a racing game of the invention.

FIG. 1 gives an overall view of a system of the invention.

The system comprises a video game system constituted by a remotely-controlled vehicle 1 (referred to by the acronym BTT for “BlueTooth Toy”, or WIT, for “WiFiToy”) together with a portable console 3 that communicates with the vehicle 1 via a Bluetooth link 5. The vehicle 1 may be remotely-controlled by the portable console 3 via the Bluetooth link 5.

The vehicle 1 is in communication with a plurality of satellites 7 via a GPS sensor on board the vehicle 1.

The portable console 3 may be fitted with a broadband wireless connection giving access to the Internet, such as a WiFi connection 9.

This connection enables the console 3 to access the Internet 11.

Alternatively, if the portable console is not itself fitted with an Internet connection, it is possible to envisage an indirect connection to the Internet 13 via a computer 15.

A database 17 containing aerial images of the Earth is accessible via the Internet 11.

By way of example, FIGS. 2a and 2b show two different embodiments of the remotely-controlled vehicle 1. In FIG. 2a, the remotely-controlled vehicle 1 is a race car. This race car 1 has a video camera 19 incorporated in its roof. The image delivered by the video camera 19 is communicated to the portable console 3 via the Bluetooth link 5 in order to be displayed on the screen of the portable console 3.

FIG. 2b shows that the remotely-controlled toy 1 may also be constituted by a four-propeller “quadricopter” 21. As for the race car, the quadricopter 1 has a video camera 19 in the form of a dome located at the center thereof.

Naturally, the remotely-controlled vehicle 1 may also be in the form of some other vehicle, e.g. in the form of a boat, a motorcycle, or a tank.

To summarize, the remotely-controlled vehicle 1 is essentially a piloted vehicle that transmits video, and that has sensors associated therewith.

FIGS. 3a and 3b are diagrams showing the main electronic components of the remotely-controlled vehicle 1.

FIG. 3a shows in detail the basic electronic components. A computer 23 is connected to various peripheral elements such as a video camera 19, motors 25 for moving the remotely-controlled vehicle, and various memories 27 and 29. The memory 29 is an SD card, i.e. a removable memory card for storing digital data. The card 29 may be omitted, but it is preferably retained since it serves to record the video image delivered by the camera 19 so as to make it possible to look back through recorded video sequences.

FIG. 3b shows the additional functions on board the remotely-controlled vehicle 1. The vehicle 1 essentially comprises two additional functions: an inertial unit 31 having three accelerometers 33 and three gyros 35, and a GPS sensor 37.

The additional functions are connected to the computer 23, e.g. via a serial link. It is also possible to add a USB (universal serial bus) connection to the vehicle 1 in order to be able to update the software executed in the electronic system of the vehicle 1.

The inertial unit 31 is an important element of the vehicle 1. It serves to estimate accurately and in real time the coordinates of the vehicle. In all, it estimates nine coordinates for the vehicle: the positions X, Y, and Z of the vehicle in three-dimensional space; the angles of orientation θ, ψ, φ of the vehicle (Eulerian angles); and the speeds VX, VY, and VZ along each of the three Cartesian axes X, Y, and Z.

These movement coordinates come from the three accelerometers 33 and from the three gyros 35. These coordinates may be obtained from a Kalman filter receiving the outputs from the measurements provided by the sensors.

More precisely, the microcontroller takes the measurement and forwards it via the serial link or serial bus (serial peripheral interconnect, SPI) to the computer 23. The computer 23 mainly performs Kalman filtering and delivers the position of the vehicle 1 as determined in this way to the game console 3 via the Bluetooth connection 5. The filtering calculation may be optimized: the computer 23 knows the instructions that are delivered to the propulsion and steering motors 25. It can use this information to establish the prediction of the Kalman filter. The instantaneous position of the vehicle 1 as determined with the help of the inertial unit 31 is delivered to the game console 3 at a frequency of 25 hertz (Hz), i.e. the console receives one position per image.

If the computer 23 is overloaded in computation, the raw measurements from the inertial unit 31 may be sent to the game console 3, which can itself perform the Kalman filtering instead of the computer 23. This solution is not desirable in terms of system simplicity and coherence, since it is better for all of the video game computation to be performed by the console and for all of the data acquisition to be performed by the vehicle 1, but nevertheless it can be envisaged.

The sensors of the inertial unit 31 may be implemented in the form of piezoelectric sensors. These sensors vary considerably with temperature, which means that they need to be maintained at a constant temperature with a temperature probe and a rheostat, and that by using a temperature probe, it is necessary to measure the temperature level of the piezoelectric sensors and to compensate in software for the variations of the sensors with temperature.

The GPS sensor 37 is not an essential function of the remotely-controlled vehicle 1. Nevertheless, it provides great richness in terms of functions at modest cost. A down-market GPS suffices, operating mainly outdoors and without any need for real time tracking of the path followed, since the real time tracking of the path is performed by the inertial unit 29. It is also possible to envisage using GPS in the form of software.

The game console 3 is any portable console that is available on the market. Presently-known examples of portable consoles are the Sony portable Playstation (PSP) or the Nintendo Nintendo DS. It may be provided with a Bluetooth key (dongle) 4 (cf. FIG. 1) for communicating by radio with the vehicle 1.

The database 17 (FIG. 1) contains a library of aerial images, preferably of the entire Earth. These photos may be obtained from satellites or airplanes or helicopters. FIGS. 4a to 4c show various examples of aerial images that can be obtained from the database 17. The database 17 is accessible via the Internet so that the console 3 can have access thereto.

The aerial images downloaded from the database 17 are used by the game console 3 to create synthesized views that are incorporated in the video games that are played on the console 3.

There follows a description of the method whereby the console 3 acquires aerial images from the database 17. For this purpose, the user of the console 3 places the remotely-controlled vehicle 1 at a real location, such as in a park or a garden, where the user seeks to play. By means of the GPS sensor 37, the vehicle 1 determines its terrestrial coordinates. These are then transmitted via the Bluetooth or WiFi link 5 to the console 3. The console 3 then connects via the WiFi link 9 and the Internet to the database 17. If there is no WiFi connection at the site of play, the console 3 stores the determined terrestrial position. Thereafter the player goes to a computer 15 having access to the Internet. The player connects the console 3 to the computer and the connection between the console 3 and the database 17 then takes place indirectly via the computer 15. Once the connection between the console 3 and the database 17 has been set up, the terrestrial coordinates stored in the console 3 are used to search for aerial images or maps in the database 17 that correspond to the terrestrial coordinates. Once an image has been found in the database 17 that reproduces the terrestrial zone in which the vehicle 1 is located, the console 3 downloads the aerial image that has been found.

FIG. 5 gives an example of the geometrical definition of a two-dimensional games background used for a video game involving the console 3 and the vehicle 1.

The squares and rectangles shown in FIG. 5 represent aerial images downloaded from the database 17. The overall square A is subdivided into nine intermediate rectangles. These nine intermediate rectangles include a central rectangle that is itself subdivided into 16 squares. Of these 16 squares, the four squares at the center represent the game zone B proper. This game zone B may be loaded at the maximum definition of the aerial images, and the immediate surroundings of the game zone B, i.e. the 12 remaining squares out of the 16 squares, may be loaded with aerial images at lower definition, and the margins of the game as represented by the eight rectangles that are not subdivided, and that are located at the periphery of the subdivided central rectangle, may be loaded with aerial images from the database at even lower definition. By acting on the definition of the various images close to or far away from the center of the game, the quantity of data that needs to be stored and processed by the console can be optimized while the visual effect and putting into perspective do not suffer. The images furthest from the center of the game are displayed with definition that corresponds to their remoteness.

The downloaded aerial images are used by the console 3 to create different views that can be used in corresponding video games. More precisely, it is envisaged that the console 3 is capable of creating at least two different views from the downloaded aerial images, namely a vertical view in two dimensions (cf. FIGS. 6a and 6b) and a perspective view in three dimensions (cf. FIGS. 7a to 7c).

FIG. 6a shows an aerial image as downloaded by the console 3. The remotely-controlled vehicle 1 is located somewhere on the terrain viewed by the aerial image of FIG. 6a. This aerial image is used to create a synthesized image as shown diagrammatically in FIG. 6b. The rectangle 39 represents the aerial image of FIG. 6a. The rectangle 39 has encrusted therein three graphics objects 41 and 43. These graphics objects represent respectively the position of the remotely-controlled vehicle on the game zone represented by the rectangle 39 (cf. spot 43 that corresponds to the position of the remotely-controlled vehicle), and the positions of other real or virtual objects (cf. the crosses 41 that may, for example, represent the positions of real competitors or virtual enemies in a video game).

It is possible to envisage the software of the vehicle 1 taking care to ensure that the vehicle does not leave the game zone as defined by the rectangle 39.

FIGS. 7a and 7c show the perspective view that can be delivered by the console 3 on the basis of the downloaded aerial images. This perspective image comprises a “ground” 45 with the downloaded aerial image inserted therein. The sides 47 are virtual images in perspective at infinity, with an example thereof being shown in FIG. 7b. These images are generated in real time by the three-dimensional graphics engine of the game console 3.

As in the two-dimensional view, graphics objects 41 and 43 indicate to the player the position of the player's own vehicle (43) and the position of other players or potential enemies (41).

In order to create views, it is also possible to envisage downloading an elevation mesh from the database 17.

FIG. 8 shows the third view 49 that is envisaged in the video game system, namely the view delivered by the video camera 19 on board the remotely-controlled vehicle 1. FIG. 8 shows an example of such a view. In this real video image, various virtual graphics objects are encrusted as a function the video game being played by the player.

FIG. 9 shows the game console 3 with a display that summarizes the way in which the above-described views are presented to the player. There can clearly be seen the view 49 corresponding to the video image delivered by the video camera 19. The view 49 includes virtual encrustations 51 that, in FIG. 9, are virtual markers that define the sides of a virtual circuit. In the view 49, it is also possible to see the real hood 53 of the remotely-guided vehicle 1.

The second view 55 corresponds to the two-dimensional vertical view shown in FIGS. 6a and 6b. The view 55 is made up of the reproduction of an aerial image of the game terrain, having encrusted thereon a virtual race circuit 57 with a point 59 moving around the virtual circuit 57. The point 59 indicates the actual position of the remotely-guided vehicle 1. As a function of the video game, the two-dimensional view 55 may be replaced by a perspective view of the kind described above. Finally, the display as shown in FIG. 9 includes a third zone 61, here representing a virtual fuel gauge for the vehicle 1.

There follows a description of an example of a video game for the video game system shown in FIG. 1. The example is a car race performed on a real terrain with the help of the remotely-controlled vehicle 1 and the game console 3, with the special feature of this game being that the race circuit is not physically marked out on the real terrain but is merely positioned in virtual manner on the real game terrain on which the vehicle 1 travels.

In order to initialize the video race game, the user proceeds by acquiring the aerial image that corresponds to the game terrain in the manner described above. Once the game console 3 has downloaded the aerial image 39 reproducing a vertical view of the game terrain on which the vehicle 1 is located, the software draws a virtual race circuit 57 on the downloaded aerial image 39, as shown in FIG. 10. The circuit 57 is generated in such a manner that the virtual start line is positioned on the aerial image 39 close to the geographical position of the vehicle 1. This geographical position of the vehicle 1 corresponds to the coordinates delivered by the GPS module, having known physical values concerning the dimensions of the vehicle 1 added thereto.

Using the keys 58 on the console 3, the player can cause the circuit 57 to turn about the start line, can subject the circuit 57 to scaling while keeping the start line as the invariant point of the scaling (with scaling being performed in defined proportions that correspond to the maneuverability of the car), or can cause the circuit to slide around the start line.

It is also possible to make provision for the start line to be moved along the circuit, in which case the vehicle needs to move to the new start line in order to start a game.

This can be of use, for example when the garden where the player seeks to play the video game is not large enough to contain the circuit as initially drawn by the software. The player can thus change the position of the virtual circuit until it is indeed positioned on the real game terrain.

With a flying video toy that constitutes one of the preferred applications, e.g. a quadricopter, an inertial unit of the flying vehicle is used to stabilize it. A flight instruction is transmitted by the game console to the flying vehicle, e.g. “hover”, “turn right”, or “land”. The software of the microcontroller on board the flying vehicle makes use of its flight controls: modifying the speed of the propellers or controlling aerodynamic flight surfaces so as to make the measurements taken by the inertial unit coincide with the flight instruction.

Likewise, with a video toy of the motor vehicle type, instructions are relayed by the console to the microcontroller of the vehicle, e.g. “turn right” or “brake” or “speed 1 meter per second (m/s)”.

The video toy may have main sensors, e.g. a GPS and/or an inertial unit made up of accelerometers or gyros. It may also have additional sensors such as video camera, means for counting the revolutions of the wheels of a car, an air pressure sensor for estimating speed of a helicopter or an airplane, a water pressure sensor for determining depth in a submarine, or analog-to-digital converters for measuring electricity consumption at various points of the on-board electronics, e.g. the consumption of each electric motor for propulsion or steering.

These measurements can be used for estimating the position of the video toy on the circuit throughout the game sequence.

The measurement that is most used is that from the inertial unit that comprises accelerometers and/or gyros. This measurement can be checked by using a filter, e.g. a Kalman filter, serving to reduce noise and to combine measurements from other sensors, cameras, pressure sensors, motor electricity consumption measurements, etc.

For example, the estimated position of the vehicle 1 can be periodically recalculated by using the video image delivered by the camera 19 and by estimating movement on the basis of significant fixed points in the image scene, which are preferably high contrast points in the video image. The distance to the fixed points may be estimated by minimizing matrices using known triangulation techniques.

Position may also be recalculated over a longer distance (about 50 meters) by using GPS, in particular recent GPS modules that measure the phases of the signals from the satellites.

The speed of the video toy may be estimated by counting wheel revolutions, e.g. by using a coded wheel.

If the video toy is propelled by an electric motor, its speed can also be estimated by measuring the electricity consumption of said motor. This requires knowledge of the efficiency of the motor at different speeds, as can be measured beforehand on a test bench.

Another way of estimating speed is to use the video camera 19. For a car or a flying vehicle, the video camera 19 is stationary relative to the body of the vehicle (or at least its position is known), and its focal length is also known. The microcontroller of the video toy performs video coding of MPEG4 type, e.g. using H263 or H264 coding. Such coding involves calculation predicting the movement of a subset of the image between two video images. For example the subset may be a square of 16*16 pixels. Movement prediction is preferably performed by a physical accelerometer. The set of movements of the image subset provides an excellent measurement of the speed of the vehicle. When the vehicle is stationary, the sum of the movements of the subsets of the image is close to zero. When the vehicle is advancing in a straight line, the subsets of the image move away from the vanishing point with a speed that is proportional to the speed of the vehicle.

In the context of the race car video game, the screen is subdivided into a plurality of elements, as shown in FIG. 9. The left element 49 displays the image delivered by the video camera 19 of the car 1. The right element 55 shows the map of the race circuit together with competing cars (cf. the top right view in FIG. 9).

Indicators may display real speed (at the scale of the car). Game parameters may be added, such as the speed or the fuel consumption of the car, or they may be simulated (as for a Formula 1 grand prix race).

In the context of this video game, the console can also store races. If only one car is available, it is possible to race against oneself. Under such circumstances, it is possible to envisage displaying transparently on the screen a three-dimensional image showing the position of the car during a stored lap.

FIG. 11 shows in detail how virtual encrustations 51, i.e. race circuit markers, are adapted in the display 49 corresponding to the view from the corresponding video camera on board the vehicle 1. FIG. 11 is a side view showing the topography 63 of the real terrain on which the vehicle 1 is moving while playing the race video game. It can be seen that the ground of the game terrain is not flat, but presents ups and downs. The slope of the terrain varies, as represented by arrows 65.

Consequently, the encrustation of the circuit markers 51 in the video image cannot be static but needs to adapt as a function of the slope of the game terrain. To take this problem into account, the inertial unit 31 of the vehicle 1 has a sensor for sensing the attitude of the vehicle. The inertial sensor performs real time acquisition of the instantaneous attitude of the vehicle 1. From instantaneous attitude values, the electronics of the vehicle 1 estimate two values, namely the slope of the terrain (i.e. the long-term average of the attitude) and the roughness of the circuit (i.e. the short-term average of the attitude). The software uses the slope value to compensate the display, i.e. to move the encrusted markers 51 on the video image, as represented by arrow 67 in FIG. 11.

Provision is also made to train the software that adjusts the display of the markers 51. After the vehicle 1 has traveled a first lap round the virtual circuit 57, the values for slope and roughness all around the circuit are known, stored, and used in the prediction component of a Kalman filter that re-estimates slope and roughness on the next lap.

The encrustation of the virtual markers 51 on the video image can thus be improved by displaying only discontinuous markers and by displaying a small number of markers, e.g. only four markers on either side of the road. Furthermore, the distant markers may be of a different color and may serve merely as indications and not as real definitions of the outline of the track. In addition, the distant markers may also be placed further apart than the near markers.

Depending on the intended application, it may also be necessary to estimate the roll movement of the car in order to adjust the positions of the markers 51, i.e. to estimate any possible tilt of the car about its longitudinal axis.

The circuit roughness estimate is preferably used to extract the slope measurement from the data coming from the sensor.

In order to define accurately the shape of the ground on which the circuit is laid, a training stage may be performed by the video game. This training stage is advantageously performed before the game proper, at a slow and constant speed that is under the control of the game console. The player is asked to take a first lap around the circuit during which the measurements from the sensors are stored. At the end of the lap round the track, the elevation values of numerous points of the circuit are extracted from the stored data. These elevation values are subsequently used during the game to position the virtual markers 51 properly on the video image.

FIGS. 12a to 12c show a method of defining a common frame of reference when the race game is performed by two or more remotely-controlled vehicles 1. In this context, there are two players each having a remotely-controlled vehicle 1 and a portable console 3. These two players seek to race two cars against each other around the virtual race circuit 57 using their two vehicles 1. The initialization of such a two-player game may be performed, for example, by selecting a “two-car” mode on the consoles. This has the effect of the Bluetooth or WiFi protocol in each car 1 entering a “partner search” mode. Once the partner car has been found, each car 1 informs its own console 3 that the partner has been found. One of the consoles 1 is used for selecting the parameters of the game: selecting the race circuit in the manner described above, the number of laps for the race, etc. Then a countdown is started on both consoles: the two cars communicate with each other using the Bluetooth or WiFi protocol. In order to simplify exchanges between the various peripherals, each car 1 communicates with its own console 3 but not with the consoles of the other cars. The cars 1 then send their coordinates in real time and each car 1 sends its own coordinates and the coordinates of the competitor(s) to the console 3 from which it is being driven. On the console, the display of the circuit 55 shows the positions of the cars 1.

In such a car game, the Bluetooth protocol is in a “Scatternet” mode. One of the cars is then a “Master” and the console with which it is paired is a “Slave”, and the other car is also a “Slave”. In addition, the cars exchange their positions with each other. Such a race game with two or more remotely-controlled vehicles 1 requires the cars 1 to establish a common frame of reference during initialization of the game. FIGS. 12a to 12c show details of defining a corresponding common frame of reference.

As shown in FIG. 12a, the remotely-controlled vehicles 1 with their video cameras 19 are positioned facing a bridge 69 placed on the real game terrain. This real bridge 69 represents the starting line and it has four light-emitting diodes (LEDs) 71. Each player places the corresponding car 1 in such a manner that at least two of the LEDs 71 are visible on the screen of the player's console 3.

The LEDs 71 are of known colors and they may flash at known frequencies. In this way, the LEDs 71 can easily be identified in the video images delivered respectively by the two video cameras 19. A computer present on each of the vehicles 1 or in each of the consoles 3 processes the image and uses triangulation to estimate the position of the corresponding car 1 relative to the bridge 69.

Once a car 1 has estimated its position relative to the bridge 69, it transmits its position to the other car 1. When both cars 1 have estimated their respective positions relative to the bridge 69, the positions of the cars 1 relative to each other are deduced therefrom and the race can begin.

FIG. 12b is a view of the front of the bridge 69 showing the four LEDs 71. FIG. 12c shows the display on the console 3 during the procedure of determining the position of a vehicle 1 relative to the bridge 69. In FIG. 12c, it can clearly be seen that the computer performing image processing has managed to detect the two flashing LEDs 71, as indicated in FIG. 12c by two cross-hairs 73.

Defining a common frame of reference relative to the ground and between the vehicles is particularly useful for a race game (each vehicle needs to be referenced relative to the race circuit).

For some other video games, such as a shooting game, defining a common frame of reference is simpler: for each vehicle, it suffices to know its position relative to its competitors.

FIGS. 13a to 13c are photos corresponding to an alternative version of the race video game, the race game now involving not one or more cars 1, but rather one or more quadricopters 1 of the kind shown in FIG. 2b. Under such circumstances, where the remotely-controlled vehicle 1 is a quadricopter, the inertial unit is not only used for transmitting the three-dimensional coordinates of the toy to the console 3, but also for providing the processor on board the quadricopter 1 with the information needed by the program that stabilizes the quadricopter 1.

With a quadricopter, the race no longer takes place on a track as it does for a car, but is in three dimensions. Under such circumstances, the race follows a circuit that is no longer represented by encrusted virtual markers as shown in FIG. 9, but that is defined for example by virtual circles 75 that are encrusted in the video image (cf. FIG. 13b) as delivered by the video camera 19, said circle floating in three dimensions. The player needs to fly the quadricopter 1 through the virtual circles 75.

As for the car, three views are possible: the video image delivered by the video camera 19 together with its virtual encrustations, the vertical view relying on a downloaded aerial image, and the perceptive view likewise based on a downloaded satellite or aerial image.

FIG. 13b gives an idea of a video image of encrusted virtual circles 75 of the kind that may arise during a game involving a quadricopter.

The positioning of the race circuit on the downloaded aerial image is determined in the same manner as for a car race. The circuit is positioned by hand by the player in such a manner as to be positioned suitably as a function of obstacles and buildings. Similarly, the user can scale the circuit, can turn it about the starting point, and can cause the starting point to slide around the track. The step of positioning the circuit 57 is shown in FIG. 13a.

In the same manner as for a car race, in a race involving a plurality of quadricopters, provision is made for a separate element to define the starting line, e.g. a pylon 77 carrying three flashing LEDs or reflector elements 71. The quadricopters or drones are aligned in a common frame of reference by means of the images from their cameras 19 and the significant points in the images as represented by the three flashing LEDs 71 of the pylon 77. Because all these geometrical parameters are known (camera position, focal length, etc.), the vehicle 1 is positioned without ambiguity in a common frame of reference. More precisely, the vehicle 1 is positioned in such a manner as to be resting on the ground with the pylon 77 in sight, and then it is verified on the screen of its console 3 that all three flashing LEDs 71 can be seen. The three flashing LEDs 71 represent significant points in recognizing the frame of reference. Because they are flashing at known frequencies, they can easily be identified by the software.

Once the position relative to the pylon 77 is known, the quadricopters 1 exchange information (each conveying to the other its position relative to the pylon 77) and in this way each quadricopter 1 deduces the position of its competitor.

The race can begin from the position of the quadricopter 1 from which the pylon 77 was detected by image processing. Nevertheless, it is naturally also possible to start the race from some other position, the inertial unit being capable of storing the movements of the quadricopters 1 from their initial position relative to the pylon 77 before the race begins.

Another possible game is a shooting game between two or more vehicles. For example, a shooting game may involve tanks each provided with a fixed video camera or with a video camera installed on a turret, or indeed it may involve quadricopters or it may involve quadricopters against tanks. Under such circumstances, there is no need to know the position of each vehicle relative to a circuit, but only to know the position of each vehicle relative to the other vehicle(s). A simpler procedure can be implemented. Each vehicle has LEDs flashing at a known frequency, with known colors, and/or in a geometrical configuration that is known in advance. By using the communications protocol, each vehicle exchanges with the others information concerning its type, the positions of its LEDs, the frequencies at which they are flashing, their colors, etc. Each vehicle is placed in such a manner that at the beginning of the game, the LEDs of the other vehicle are in the field of view of its video sensor 19. By performing a triangulation operation, it is possible to determine the position of each vehicle relative to the other(s).

The game can then begin. Each vehicle, by virtue of its inertial unit and its other measurement means, knows its own position and its movement. It transmits this information to the other vehicles.

On the video console, the image of an aiming site is encrusted, e.g. in the center of the video image transmitted by each vehicle. The player can then order projectiles to be shot at another vehicle.

At the time a shot is fired, given the position forwarded by the other vehicles and its own position direction and speed, the software of the shooting vehicle can estimate whether or not the shot will reach its target. The shot may simulate a projectile that reaches it target immediately, or else it may simulate the parabolic flight of a munition, or the path of a guided missile. The initial speed of the vehicle firing the shot, the speed of the projectile, the simulation of external parameters, e.g. atmospheric conditions, can all be simulated. In this way, shooting in the video game can be made more or less complex. The trajectory of missile munitions, tracer bullets, etc., can be displayed by being superimposed on the console.

The vehicles such as land vehicles or flying vehicles can estimate the positions of other vehicles in the game. This can be done by a shape recognition algorithm making use of the image from the camera 19. Otherwise, the vehicles may be provided with portions that enable them to be identified, e.g. LEDs. These portions enable other vehicles continuously to estimate their positions in addition to the information from their inertial units as transmitted by the radio means. This enables the game to be made more realistic. For example, during a battle game against one another, one of the players may hide behind a feature of the terrain, e.g. behind a tree. Even though the video game knows the position of the adversary because of the radio means, that position will not be shown on the video image and the shot will be invalid even if it was in the right direction.

When a vehicle is informed by its console that it has been hit, or of some other action in the game, e.g. simulating running out of fuel, a breakdown, or bad weather, a simulation sequence specific to the video game scenario may be undertaken. For example, with a quadricopter, it may start to shake, no longer fly in a straight line, or make an emergency landing. With a tank, it may simulate damage, run more slowly, or simulate the fact that its turret is jammed. Video transmission may also be modified, for example the images may be blurred, dark, or effects may be encrusted on the video image, such as broken cockpit glass.

The video game of the invention may combine:
player actions: driving the vehicles;
virtual elements: a race circuit or enemies displayed on the game console; and
simulations: instructions sent to the video toy to cause it to modify its behavior, e.g. an engine breakdown or a speed restriction on the vehicle, or greater difficulty in driving it.

These three levels of interaction make it possible to increase the realism between the video game on the console and a toy provided with sensors and a video camera.

1. A method of defining a game zone (B) for a video game system (1, 3), the system comprising a remotely-controlled vehicle (1) and an electronic entity (3) used for remotely controlling the vehicle (1), the method being characterized in that it comprises the following steps:
acquiring the terrestrial position of the vehicle (1) via a position sensor (37) arranged on the vehicle (1);
transmitting the terrestrial position of the vehicle (1) to the electronic entity (3);
establishing a connection between the electronic entity (3) and a database (17) containing aerial images of the Earth;
in the database (17), selecting an aerial image corresponding to the terrestrial position transmitted to the electronic entity (3);
downloading the selected aerial image from the database (17) to the electronic entity (3); and
incorporating the downloaded aerial image in a video game being executed on the electronic entity (3).

2. A method according to claim 1, wherein the video game being executed on the electronic entity (3) is a circuit game, the incorporation of the aerial image in the game comprising positioning a virtual circuit (57) on the downloaded aerial image to enable a game to be implemented that involves the remotely-controlled vehicle (1) on the real terrain corresponding to the aerial image.

3. A method according to claim 2, the positioning of the virtual circuit (57) on the aerial image including adapting the virtual circuit (57) to the aerial image, in particular by shifting, rotating, pivoting, and/or scaling the circuit.

4. A method according to claim 3, the virtual circuit (57) being positioned in such a manner that its starting line is situated close to the location of the aerial image corresponding to the real position of the vehicle (1).

5. A method according to claim 4, the adaptation of the circuit by rotation being performed by rotation about the center of the starting line.

6. A method according to claim 4, the adaptation of the circuit by scaling conserving the starting line as an invariant point.

7. A method according to claim 4, further including shifting the starting line by causing the representation of the circuit to slide over the starting line.

8. A method according to claim 1, wherein the video game being executed on the electronic entity (3) is a circuit game, incorporation of the aerial image in the game comprising a step consisting in drawing a virtual circuit (57) on the downloaded aerial image by connecting predefined circuit elements, such as straight lines, turns, a finish line, in order to enable a game to be implemented that involves the remotely-controlled vehicle (1) on the real terrain corresponding to the aerial image.

9. A method according to claim 8, including a step of adapting predefined circuit elements to the aerial image, in particular by scaling or moving them in translation or in rotation.

10. A method according to claim 1, wherein the video game being executed on the electronic entity (3) is a circuit game, the incorporation of the aerial image in the game including a step of defining a virtual circuit (57) on the downloaded aerial image by defining discrete points of passage in a three-dimensional space so as to enable a game to be implemented involving the remotely-controlled vehicle (1) on the real terrain corresponding to the aerial image.

11. A method according to claim 1, further comprising a step of moving points of passage by scaling, or by movement in translation or in rotation, in particular in order to define a three-dimensional circuit.

12. A method according to claim 1, wherein the incorporation of the aerial image in the video game comprises creating a perspective image having five faces, the ground (45) of the perspective image corresponding to the aerial image and the walls (47) of the perspective image corresponding to synthesized images at infinity.

13. A method according to claim 1, wherein the remotely-controlled vehicle (1) is a terrestrial vehicle, in particular a race car or a tank, or an aerial vehicle, in particular a quadricopter.

14. A method according to claim 1, wherein the electronic entity (3) is a portable unit, in particular a portable game console or a mobile telephone.

15. A method according to claim 1, wherein communication between the electronic entity (3) and the remotely-controlled vehicle (1) takes place by short-range radio transmission (5), in particular by Bluetooth or WiFi protocol.

16. A method according to claim 1, wherein the database (17) forms part of a computer network (11), in particular the Internet, and the connection between the electronic entity (3) and the database (17) takes place via a wireless local area network (9).

17. A method according to claim 1, wherein the position sensor (37) is a module of a satellite positioning system, in particular a GPS module.

18. A method according to claim 2, the virtual circuit (57) being positioned in such a manner that its starting line is situated close to the location of the aerial image corresponding to the real position of the vehicle (1).

19. A method according to claim 5, further including shifting the starting line by causing the representation of the circuit to slide over the starting line.

20. A method according to claim 6, further including shifting the starting line by causing the representation of the circuit to slide over the starting line.
